(19) United States
(12) Patent Application Publication
(10) Pub. No.: US 2011/0311364 A1
(43) Pub. Date: Dec. 22, 2011

(54) Balanced Lift Wind Turbine

(76) Inventor: Michael D. CONNER, Phoenixville, PA (US)

(21) Appl. No.: 12/818,231

(22) Filed: Jun. 18, 2010

(51) Int. Cl. F03D 11/02; F03D 3/00; F03D 9/00

(52) U.S. Cl. 416/197 A; 290/55; 416/202; 416/243

(57) ABSTRACT

A vertical axis wind turbine that utilizes a unique semi-circular, angled, scoop design and frame to fully harness wind energy. The shape of the scoops maximizes wind collection while minimizing wind resistance. The angle of the scoops allows the wind turbine to catch wind, including updrafts, to produce a rotational and balanced lifting force on the scoop system. This balanced lift is possible due to a stable frame which maintains a fixed position of the vertical axis.

### FIELD OF THE INVENTION

The invention relates generally to a wind turbine that is able to generate electrical power from wind energy. It is the object of the present invention to effectively and efficiently harness the winds energy for converting into electrical energy.

### BACKGROUND OF THE INVENTION

The most common wind turbines today make use of a horizontal axis motor shaft to harness mechanical energy and transform it into electrical energy. Other wind turbines make use of a vertical axis motor shaft to harness wind energy without needing to be turned into the wind. Nearly all current wind turbines employ airfoil shaped blades to catch wind energy.

This invention is a vertical axis wind turbine that uses semi-circular shaped scoops to catch wind energy. This shape minimizes leeward resistance while maximizing windward collection. In addition, the scoops are distinctively angled so updrafts can be caught. This angle makes the invention uniquely suited for mounting on buildings along the peak of slopped roofs, or the perimeter of flat roofs, where wind currents are increased. Due to the weight of the apparatus and the affects of wind flow, all other vertical axis wind turbines weigh down or torque the motor shaft which dampens the ability to harness wind energy. The present invention overcomes this problem by introducing a top bearing and frame structure to lower any resistance that the motor shaft may experience. With less resistance from the frame and increased wind collection from the scoops, the present invention is able to maximize the energy harnessed from wind.

### BRIEF DESCRIPTION OF THE DRAWINGS

FIG. 1 is a perspective view of a completed apparatus of the present invention.

FIG. 2 is a perspective view of the top of the present invention without the scoops attached.

FIG. 3 is an exploded view of the top of the present invention without the scoops and supports attached.

FIG. 4 is an exploded view of the top fixture with the headers.

FIG. 5 is a perspective view of the base of the present invention without the scoops attached.

FIG. 6 is an exploded view of the base of the present invention without the scoops and supports attached.

FIG. 7 is an exploded view of the base fixture with the footers.

FIG. 8 is a bottom plan view of the present invention.

FIG. 9 is a diagram of the first scoop, the first top arm, and the first bottom arm without the corresponding arm nuts and washers.

FIG. 10 is a diagram of the second scoop, the second top arm, and the second bottom arm without the corresponding arm nuts and washers.

FIG. 11 is a diagram of the third scoop, the third top arm, and the third bottom arm without the corresponding arm nuts and washers.

FIG. 12 is a diagram of the fourth scoop, the fourth top arm, and the fourth bottom arm without the corresponding arm nuts and washers.

### DETAIL DESCRIPTIONS OF THE INVENTION

All illustrations of the drawings are for the purpose of describing selected versions of the present invention and are not intended to limit the scope of the present invention.

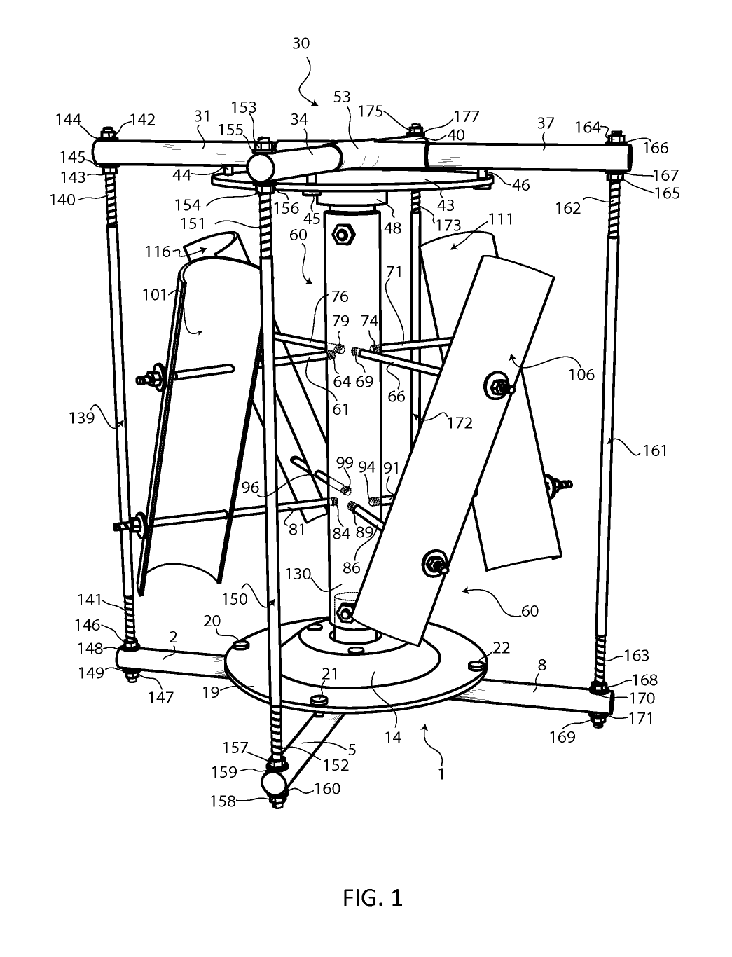

In reference to FIG. 1, the Balanced Lift Wind Turbine comprises of separate main sections including a base 1, a top 30, a scoop support 60, a first frame support 139, a second frame support 150, a third frame support 161, and a fourth frame support 172.

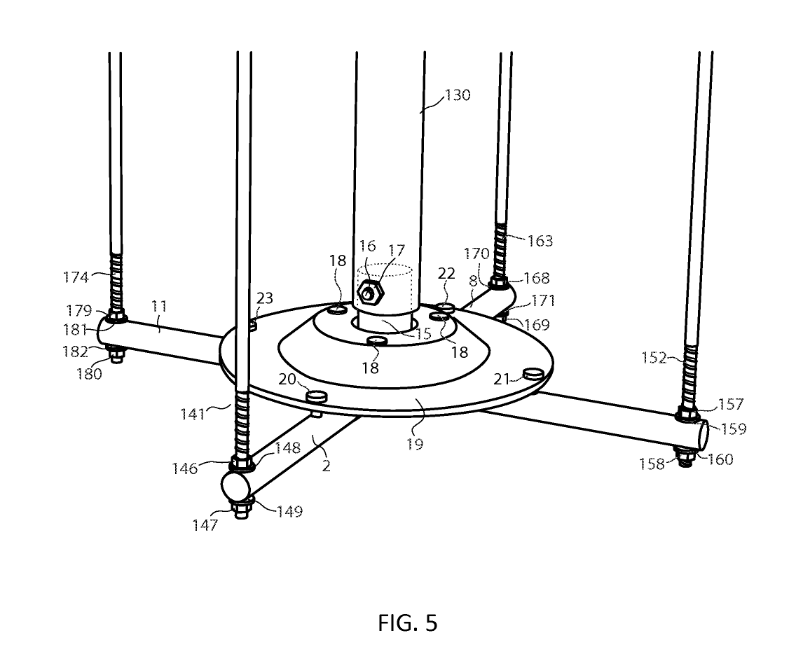

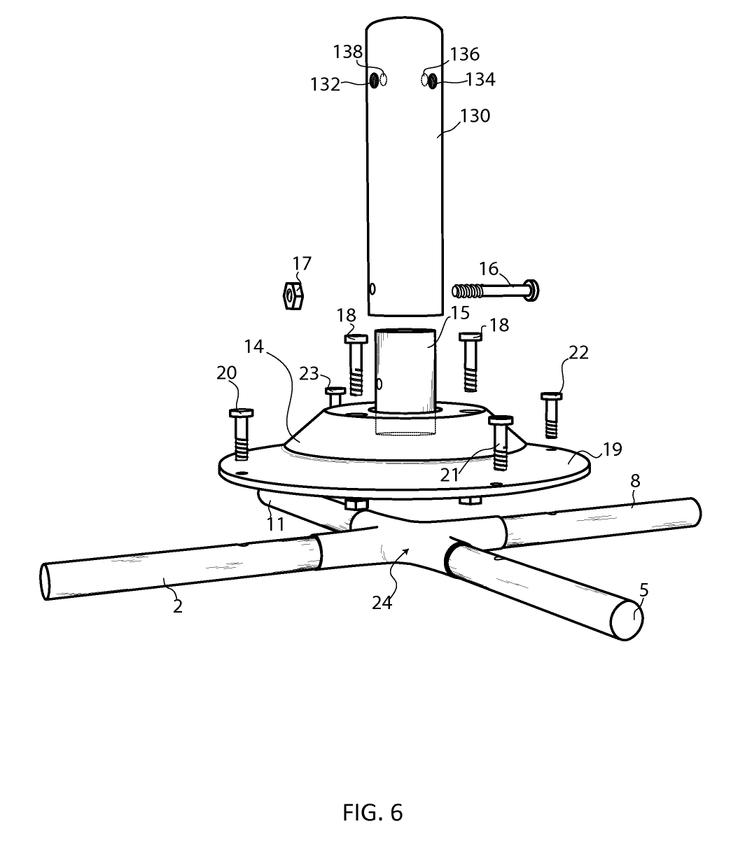

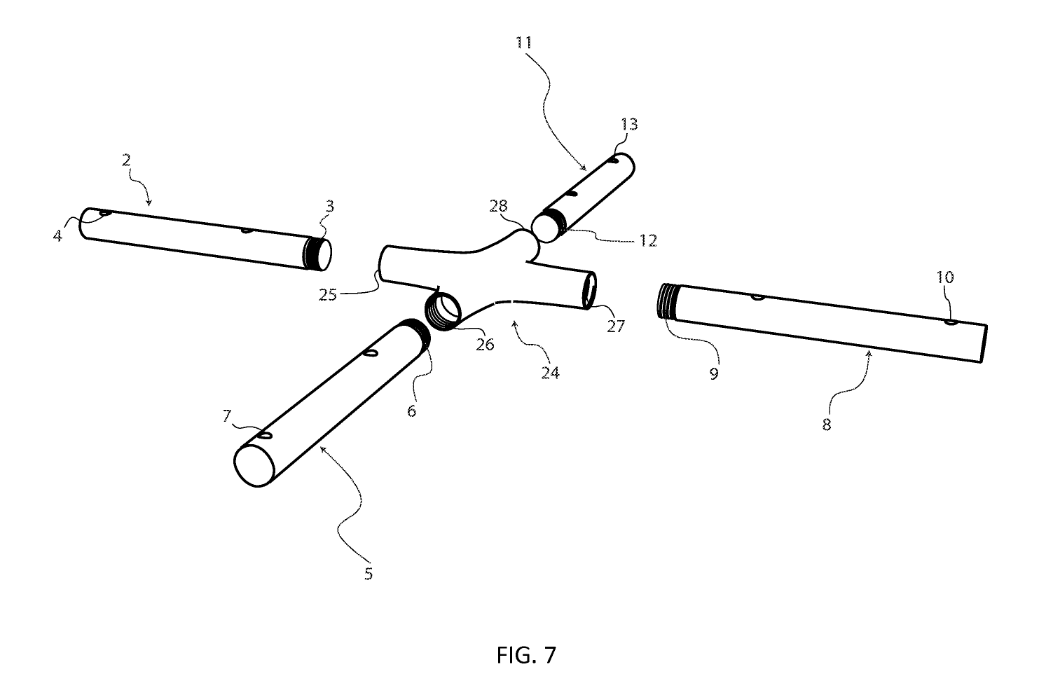

In reference to FIG. 1, FIG. 5, FIG. 6, and FIG. 7, the base 1 comprises of sub-components including a first footer 2, a second footer 5, a third footer 8, a fourth footer 11, a generator 14, at least one generator fastener 18, a base plate 19, a first base bolt 20, a second base bolt 21, a third base bolt 22, a fourth base bolt 23, and a base fixture 24. The first footer 2 comprises of a first footer fixture threaded end 3 and a first footer support hole 4. The second footer 5 comprises of a second footer fixture threaded end 6 and a second footer support hole 7. The third footer 8 comprises of a third footer fixture threaded end 9 and a third footer support hole 10. The fourth footer 11 comprises of a fourth footer fixture threaded end 12 and a fourth footer support hole 13. The generator 14 comprises of a sub-shaft 15, a generator bolt 16, and a generator nut 17. The generator can be substituted with an alternator for creating alternating current rather than direct current. The base fixture 24 comprises of a first threaded footer fixture 25, a second threaded footer fixture 26, a third threaded footer fixture 27, and a fourth threaded footer fixture 28. The first footer 2 is connected to the first threaded footer fixture 25 by the first footer fixture threaded end 3. The second footer 5 is connected to the second threaded footer fixture 26 by the second footer fixture threaded end 6. The third footer 8 is connected to the third threaded footer fixture 27 by the third footer fixture threaded end 9. The fourth footer 11 is connected to the fourth threaded footer fixture 28 by the fourth footer fixture threaded end 12. Once all of the footers are secured to the corresponding fixture, the base plate 19 bolted onto each of the footers with the first base bolt 20, the second base bolt 21, the third base bolt 22, and the fourth base bolt 23. The first base bolt 20 will secure the base plate 19 to the first footer 2. The second base bolt 21 will secure the base plate 19 to the second footer 5. The third base bolt 22 will secure the base plate 19 to the third footer 8. The fourth base bolt 23 will secure the base plate 19 to the fourth footer 11. Once the base plate 19 has been fastened onto all of the footers, the generator 14 is then fastened to the base plate 19. The generator 14 is fastened onto the base plate 19 by the at least one generator fastener 18.

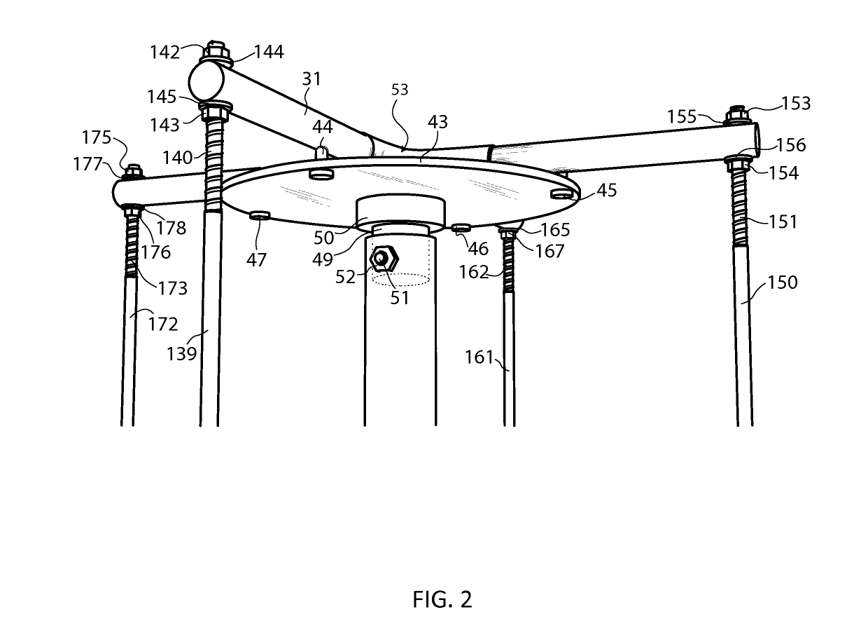

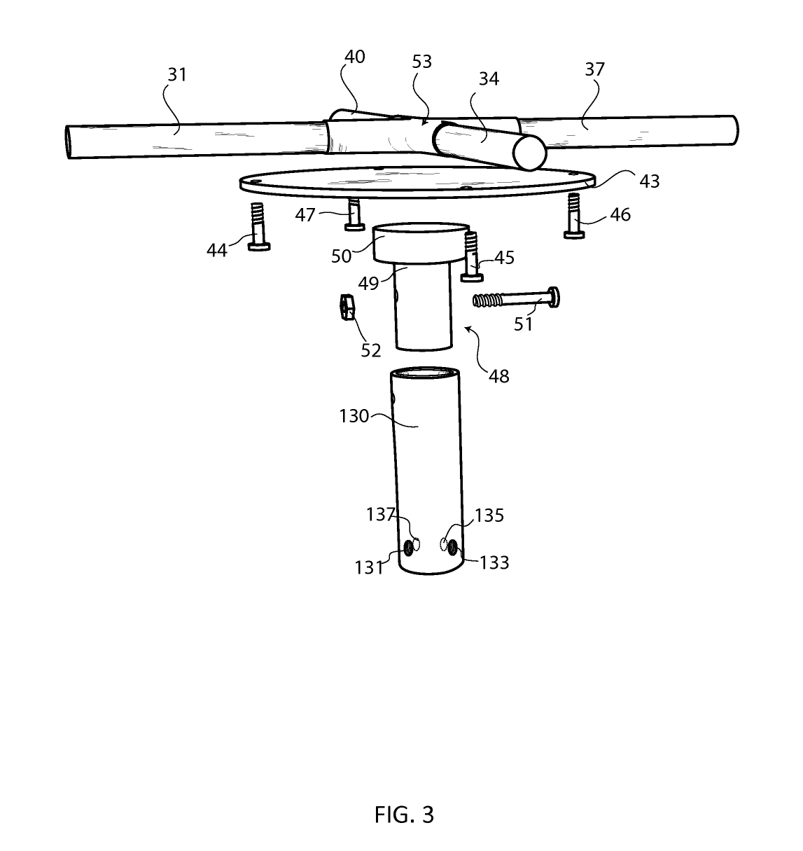

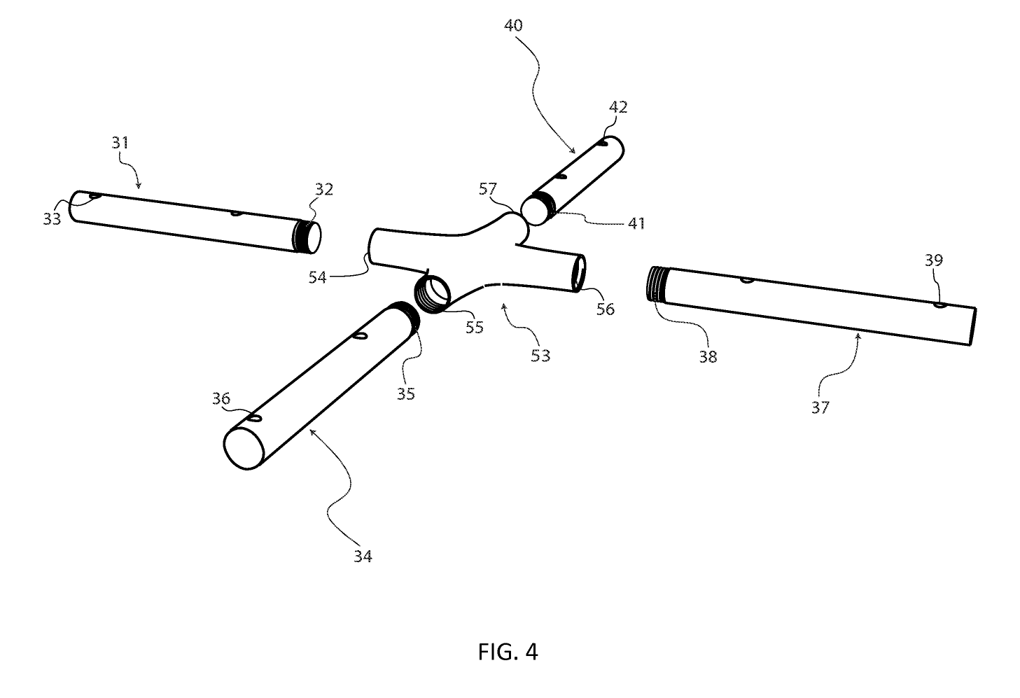

In reference to FIG. 1, FIG. 2, FIG. 3, and FIG. 4, the top 30 comprises of a first header 31, a second header 34, a third header 37, a fourth header 40, a top plate 43, a first top bolt 44, a second top bolt 45, a third top bolt 46, a fourth top bolt 47, a bearing 48, and a top fixture 53. The first header 31 comprises of a first header fixture threaded end 32 and a first header support hole 33. The second header 34 comprises of a second header fixture threaded end 35 and a second header support hole 36. The third header 37 comprises of a third header fixture threaded end 38 and a third header support hole 39. The fourth header 40 comprises of a fourth header fixture threaded end 41 and a fourth header support hole 42. The bearing 48 comprises an inner collar 49, an outer collar 50, a bearing bolt 51, and a bearing nut 52. The top fixture 53 comprises of a first threaded header fixture 54, a second threaded header fixture 55, a third threaded header fixture 56, a fourth threaded header fixture 57. The top fixture 53 is the main body which connects all of the four headers together. The first header 31 is connected to the first threaded header fixture 54 by the first header fixture threaded end 32. The second header 34 is connected to the second threaded header fixture 55 by the second header fixture threaded end 35. The third header 37 is connected to the third threaded header fixture 56 by the third header fixture threaded end 38. The fourth header 40 is connected to the fourth threaded header fixture 57 by the fourth header fixture threaded end 41. Once all the headers have been secured onto the corresponding fixtures on the top fixture 53, the top plate 43 is bolted to the all of the headers. To make sure all the headers are secure, the top plate 43 is bolted onto each of the headers with the first top bolt 44, the second top bolt 45, the third top bolt 46, and the fourth top bolt 47. The first top bolt 44 will secure the top plate 43 to the first header 31. The second top bolt 45 will secure the top plate 44 to the second header 34. The third top bolt 46 will secure the top plate 44 to the third header 37. The fourth top bolt 47 will secure the top plate 44 to the fourth header 40. The top plate is bolted underneath the top fixture 53 to the headers. Once secured onto the headers, the bearing 48 is connected to the top plate 43 by the outer collar 50 through welding. The welding will secure the bearing 48 to the top plate 43 for a stable area for the inner collar 49 of the bearing 48 to rotate about.

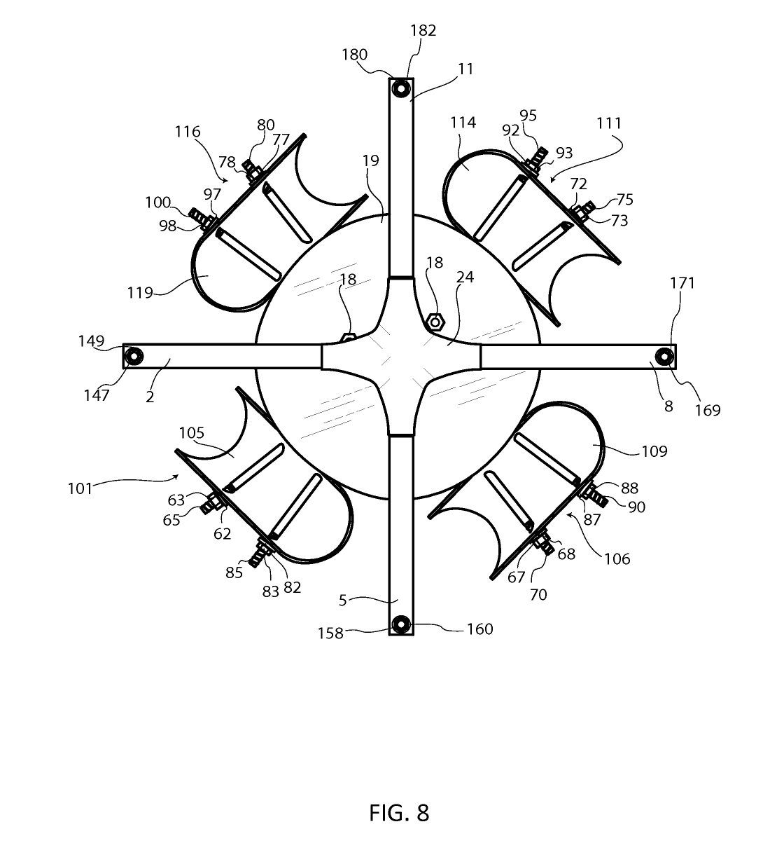

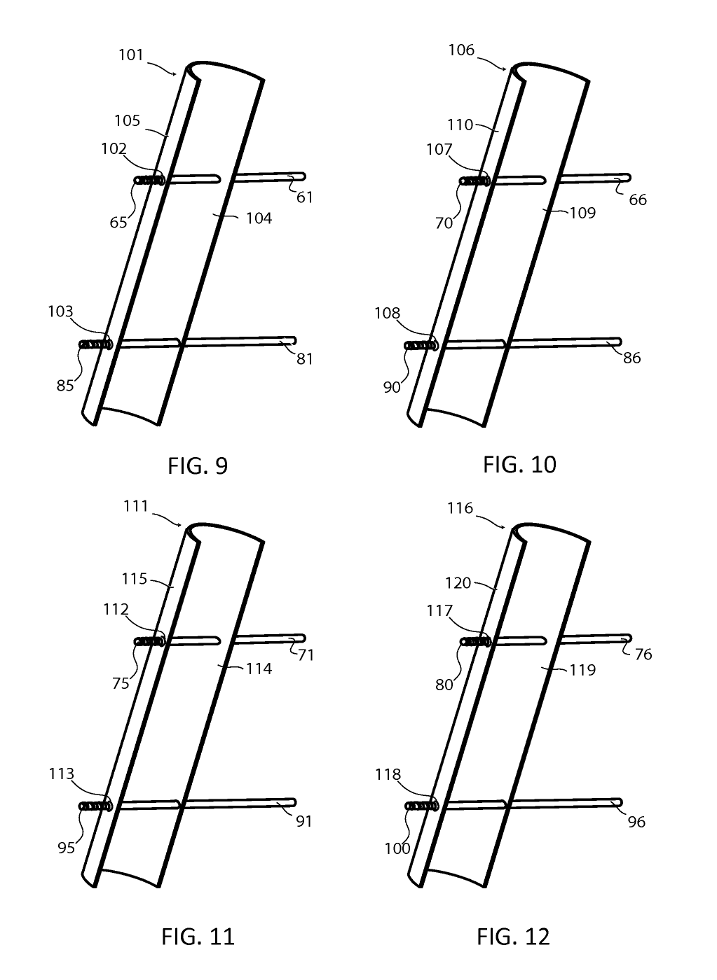

In reference to FIG. 1, FIG. 3, FIG. 6, FIG. 8, FIG. 9, FIG. 10, FIG. 11, and FIG. 12, the scoop support 60 comprises of the a first top arm 61, a second top arm 66, a third top arm 71, a fourth top arm 76, a first bottom arm 81, a second bottom arm 86, a third bottom arm 91, a fourth bottom arm 96, a first scoop 101, a second scoop 106, a third scoop 111, a fourth scoop 116, and a shaft 130. The shaft 130 comprises of a first top arm fixture 131, a first bottom arm fixture 132, a second top arm fixture 133, a second bottom arm fixture 134, a third top arm fixture 135, a third bottom arm fixture 136, a fourth top arm fixture 137, and a fourth bottom arm fixture 138. The first scoop 101 is connected to the shaft 130 by the first top arm 61 and the first bottom arm 81. The shaft 130 is a pipe of any type of sturdy material able to withstanding large amounts of stress. The first top arm 61 comprises of a first top arm washer 62, first top arm nut 63, first top threaded support end 64, and a first top threaded scoop end 65. The first top arm 61 is connected to the shaft 130 by the first top threaded end 64 being fixed to the first top arm fixture 131. The first bottom arm 81 comprises of a first bottom arm washer 82, a first bottom arm nut 83, a first bottom threaded support end 84, and a first bottom threaded scoop end 85. The first bottom arm 81 is connected to the shaft 130 by the first bottom threaded support end 64 being fixed to the first bottom arm fixture 132. The first scoop 101 comprises of a first top arm hole pair 102, a first bottom arm hole pair 103, a first concave side 104, and a first convex side 105. The first top arm 61 is connected to the first scoop 101 by fixing the first top threaded scoop end 65 to the first top arm hole pair 102 with the first top arm washer 62 and the first top arm nut 63. The first scoop 101 is connected to the first top arm 61 and the first bottom arm 81 so that the first concave side 104 is angled facing down while the first convex side 105 is angled facing up. The second scoop 106 is connected to the shaft 130 by the second top arm 66 and the second bottom arm 86. The second top arm 66 comprises of a second top arm washer 67, second top arm nut 68, second top threaded support end 69, and a second top threaded scoop end 70. The second top arm 66 is connected to the shaft 130 by the second top threaded end 69 being fixed to the second top arm fixture 133. The second bottom arm 86 comprises of a second bottom arm washer 87, a second bottom arm nut 88, a second bottom threaded support end 89, and a second bottom threaded scoop end 90. The second bottom arm 86 is connected to the shaft 130 by the second bottom threaded support end 69 being fixed to the second bottom arm fixture 134. The second scoop 106 comprises of at second top arm hole pair 107, a second bottom arm hole pair 108, a second concave side 109, and a second convex side 110. The second top arm 66 is connected to the second scoop 106 by fixing the second top threaded scoop end 70 to the second top arm hole pair 107 with the second top arm washer 67 and the second top arm nut 68. The second scoop 106 is connected to the second top arm 66 and the second bottom arm 86 so that the second concave side 109 is angled facing down while the second convex side 110 is angled facing up. The third scoop 111 is connected to the shaft 130 by the third top arm 71 and the third bottom arm 91. The third top arm 71 comprises of a third top arm washer 72, third top arm nut 73, third top threaded support end 74, and a third top threaded scoop end 75. The third top arm 71 is connected to the shaft 130 by the third top threaded end 74 being fixed to the third top arm fixture 135. The third bottom arm 91 comprises of a third bottom arm washer 92, a third bottom arm nut 93, a third bottom threaded support end 94, and a third bottom threaded scoop end 95. The third bottom arm 91 is connected to the shaft 130 by the third bottom threaded support end 74 being fixed to the third bottom arm fixture 136. The third scoop 111 comprises of at third top arm hole pair 112, a third bottom arm hole pair 113, a third concave side 114, and a third convex side 115. The third top arm 71 is connected to the third scoop 111 by fixing the third top threaded scoop end 75 to the third top arm hole pair 112 with the third top arm washer 72 and the third top arm nut 73. The third scoop 111 is connected to the third top arm 71 and the third bottom arm 91 so that the third concave side 114 is angled facing down while the third convex side 115 is angled facing up. The fourth scoop 116 is connected to the shaft 130 by the fourth top arm 76 and the fourth bottom arm 96. The fourth top arm 76 comprises of a fourth top arm washer 77, fourth top arm nut 78, fourth top threaded support end 79, and a fourth top threaded scoop end 80. The fourth top arm 76 is connected to the shaft 130 by the fourth top threaded end 79 being fixed to the fourth top arm fixture 137. The fourth bottom arm 96 comprises of a fourth bottom arm washer 97, fourth bottom arm nut 98, fourth bottom threaded support end 99, and a fourth bottom threaded scoop end 100. The fourth bottom arm 96 is connected to the shaft 130 by the fourth bottom threaded support end 79 being fixed to the fourth bottom arm fixture 138. The fourth scoop 116 comprises of at fourth top arm hole pair 117, a fourth bottom arm hole pair 118, a fourth concave side 119, and a fourth convex side 120. The fourth top arm 76 is connected to the fourth scoop 116 by fixing the fourth top threaded scoop end 80 to the fourth top arm hole pair 117 with the fourth top arm washer 77 and the fourth top arm nut 78. The fourth scoop 116 is connected to the fourth top arm 76 and the fourth bottom arm 96 so that the fourth concave side 119 is angled facing down while the fourth convex side 120 is angled facing up. The shape of the first scoop, the second scoop, the third scoop, and the fourth scoop is a semi-circular U-shape. This type of design will help the present invention to efficiently harness wind energy.

In reference to FIG. 1, FIG. 2, FIG. 4, FIG. 5, and FIG. 7, the invention is structurally supported by the first frame support 139, the second frame support 150, the third frame support 161, and the fourth frame support 172. The first frame support 139 comprises of a first threaded header end 140, a first threaded base end 141, a first top header nut 142, a first bottom header nut 143, a first top header washer 144, a first bottom header waster 145, a first top footer nut 146, a first bottom footer nut 147, a first top footer washer 148, and a first bottom footer washer 149. The second frame support 150 comprises of a second threaded header end 151, a second threaded base end 152, a second top header nut 153, a second bottom header nut 154, a second top header washer 155, a second bottom header waster 156, a second top footer nut 157, a second bottom footer nut 158, a second top footer washer 159, and a second bottom footer washer 160. The third frame support 161 comprises of a third threaded header end 162, a third threaded base end 163, a third top header nut 164, a third bottom header nut 165, a third top header washer 166, a third bottom header waster 167, a third top footer nut 168, a third bottom footer nut 169, a third top footer washer 170, and a third bottom footer washer 171. The fourth frame support 172 comprises of a fourth threaded header end 173, a fourth threaded base end 174, a fourth top header nut 175, a fourth bottom header nut 176, a fourth top header washer 177, a fourth bottom header waster 178, a fourth top footer nut 179, a fourth bottom footer nut 180, a fourth top footer washer 181, and a fourth bottom footer washer 182. The first frame support 139 is connected to the first header 31 and the first footer 2 by the first threaded header end 140 and the first threaded base end 141, respectively. The first bottom header nut 143 is twisted onto the first threaded header end 140 and the first bottom header washer 145 is placed over the first bottom header nut 143. The first threaded header end 140 is then inserted through the first header support hole 33. The first header 31 is then stabilized to the first frame support 139 by fastening the first top header nut 142 and first top header washer 144 to the first threaded header end 140. The first top footer nut 146 is twisted onto the first threaded base end 141 and the first top footer washer 148 is placed under the first bottom header nut 143. The first threaded base end 141 is then inserted through the first footer support hole 4. The first footer 2 is then stabilized to the first frame support 139 by fastening the first bottom footer nut 147 and first bottom footer washer 149 to the first threaded base end 141. The second frame support 150 is connected to the second header 34 and the second footer 5 by the second threaded header end 151 and the second threaded base end 152, respectively. The second bottom header nut 154 is twisted onto the second threaded header end 151 and the second bottom header washer 156 is placed over the second bottom header nut 154. The second threaded header end 151 is then inserted through the second header support hole 36. The second header 34 is then stabilized to the second frame support 150 by fastening the second top header nut 153 and second top header washer 155 to the second threaded header end 151. The second top footer nut 157 is twisted onto the second threaded base end 152 and the second top footer washer 159 is placed under the second bottom header nut 154. The second threaded base end 152 is then inserted through the second footer support hole 7. The second footer 5 is then stabilized to the second frame support 150 by fastening the second bottom footer nut 158 and second bottom footer washer 160 to the second threaded base end 152. The third frame support 161 is connected to the third header 37 and the third footer 8 by the third threaded header end 162 and the third threaded base end 163, respectively. The third bottom header nut 165 is twisted onto the third threaded header end 162 and the third threaded header washer 167 is placed over the third bottom header nut 165. The third threaded header end 162 is then inserted through the third header support hole 39. The third header 37 is then stabilized to the third frame support 161 by fastening the third top header nut 164 and third top header washer 166 to the third threaded header end 162. The third top footer nut 168 is twisted onto the third threaded base end 163 and the third top footer washer 170 is placed under the third bottom header nut 165. The third threaded base end 163 is then inserted through the third footer support hole 10. The third footer 8 is then stabilized to the third frame support 161 by fastening the third bottom footer nut 169 and third bottom footer washer 171 to the third threaded base end 163. The fourth frame support 172 is connected to the fourth header 40 and the fourth footer 11 by the fourth threaded header end 173 and the fourth threaded base end 174, respectively. The fourth bottom header nut 176 is twisted onto the fourth threaded header end 173 and the fourth bottom header nut 178 is placed over the fourth bottom header nut 176. The fourth threaded header end 173 is then inserted through the fourth header support hole 42. The fourth header 40 is then stabilized to the fourth frame support 172 by fastening the fourth top header nut 176 and fourth top header washer 177 to the fourth threaded header end 173. The fourth top footer nut 179 is twisted onto the fourth threaded base end 174 and the fourth top footer washer 181 is placed under the fourth bottom header nut 176. The fourth threaded base end 174 is then inserted through the fourth footer support hole 13. The fourth footer 11 is then stabilized to the fourth frame support 172 by fastening the fourth bottom footer nut 180 and fourth bottom footer washer 182 to the fourth threaded base end 174. These nuts can be adjusted to vary the height of the present invention depending on scoop sizes and frame support lengths. The unique frame structure of the present invention also allows for convenient replacement of components. The ability of the frame to extend in height and create more space allow for easy separation and removal of the generator 14.

In reference to FIG. 1 and FIG. 6, the shaft 130 is connected to the generator 14 at the sub-shaft 15 by the generator bolt 16 and the generator nut 17. The sub-shaft 15 is the rotating portion of the generator 14 that where the mechanical energy is collected. The outer diameter of the sub-shaft 15 is the same as the inner diameter of the shaft 130. This will allow a tight connection between the two components. To allow the transfer of mechanical energy from the scoop support 60 to the generator 14, a hole is drilled through the shaft 130 and sub-shaft 15 and stabilized with the generator nut 17 and generator bolt 16. The generator bolt 16 will allow the sub-shaft 15 to rotate as the shaft 130 is rotating.

In reference to FIG. 1 and FIG. 3, the shaft 130 is connected to the bearing 48 at the inner collar 49 by the bearing bolt 51 and bearing nut 52. The inner collar 49 is the rotating portion of the bearing 48. The inner collar 49 is a protruding component of the bearing 48 that has an outer diameter equal to the inner diameter of the shaft 130. This will allow for a tight connection between the two components. The inner collar 49 serves as a rotating support for the shaft 130. To stabilize the shaft 130 to the inner collar 49, a hole is drilled through the connection and the bearing nut 52 and bearing bolt 51 is used to fasten the two together.

The angling of the scoops allows the present invention to fully harness the wind's energy by a balance lift force on the scoop support 60. This balancing lift on the scoop support 60 will reduce any friction that may occur during the spinning of the turbine due to the weight of the scoops, allowing most of the energy harnessed by the wind completely being converted into electrical energy. The unique angling and curvature of the scoops also allow for the present invention to catch updrafts of wind for full harness of energy.

Although the invention has been explained in relation to its preferred embodiment, it is to be understood that many other possible modifications and variations can be made without departing from the spirit and scope of the invention as hereinafter claimed.

What is claimed is:

1. A Balanced Lift Wind Turbine comprises,
a base;
a top;
a scoop support;
a first frame support;
a second frame support;
a third frame support;
a fourth frame support;
the base comprises of a first footer, a second footer, a third footer, a fourth footer, a base plate, a base fixture, a generator, and at least one generator fastener;
the top comprises of a first header, a second header, a third header, a fourth header, a top plate, a bearing, and a top fixture;
the scoop support comprises of a first scoop, a second scoop, a third scoop, a fourth scoop, a first top arm, a second top arm, a third top arm, a fourth top arm, a first bottom arm, a second bottom arm, a third bottom arm, a fourth bottom arm, and a shaft;
the first scoop being positioned at a predetermined angle;
the second scoop being positioned at a predetermined angle;
the third scoop being positioned at a predetermined angle;
the fourth scoop being positioned at a predetermined angle;
the first footer comprises of a first footer fixture threaded end, a first footer support hole;
the second footer comprises of a second footer fixture threaded end, a second footer support hole;
the third footer comprises of a third footer fixture threaded end, a third footer support hole;
the fourth footer comprises of a fourth footer fixture threaded end, a fourth footer support hole;
the first header comprises of a first header fixture threaded end, a first header support hole;
the second header comprises of a second header fixture threaded end, a second header support hole;
the third header comprises of a third header fixture threaded end, a third header support hole; and
the fourth header comprises of a fourth header fixture threaded end, a fourth header support hole.

2. The Balanced Lift Wind Turbine as claimed in claim 1 comprises,
the generator comprises of a sub-shaft, generator bolt, and a generator nut;
the base fixture comprises of a first threaded footer fixture, a second threaded footer fixture, a third threaded footer fixture, and a fourth threaded footer fixture;
a first base bolt;
a second base bolt;
a third base bolt; and
a fourth base bolt.

3. The Balanced Lift Wind Turbine as claimed in claim 1 comprises,
the bearing comprising of an outer collar, an inner collar, a bearing bolt, and a bearing nut;
the top fixture comprising of a first threaded header fixture, a second threaded header fixture, a third threaded header fixture, and a fourth threaded header fixture;
a first top bolt;
a second top bolt;
a third top bolt; and
a fourth top bolt.

4. The Balanced Lift Wind Turbine as claimed in claim 1 comprises,
the first top arm comprises of a first top arm washer, a first top arm nut, a first top arm threaded shaft end, and a first top arm threaded scoop end;
the second top arm comprises of a second top arm washer, a second top arm nut, a second top arm threaded shaft end, and a second top arm threaded scoop end;
the third top arm comprises of a third top arm washer, a third top arm nut a third top arm threaded shaft end, and a third top arm threaded scoop end;
the fourth top arm comprises of a fourth top arm washer, a fourth top arm nut, a fourth top arm threaded shaft end, and a fourth top arm threaded scoop end;
the first bottom arm comprises of a first bottom arm washer, a first bottom arm nut, a first bottom arm threaded shaft end, and a first bottom arm threaded scoop end;
the second bottom arm comprises of a second bottom arm washer, a second bottom arm nut, a second bottom arm threaded shaft end, and a second bottom arm threaded scoop end;
the third bottom arm comprises of a third bottom arm washer, a third bottom arm nut a third bottom arm threaded shaft end, and a third bottom arm threaded scoop end;
the fourth bottom arm comprises of a fourth bottom arm washer, a fourth bottom arm nut, a fourth bottom arm threaded shaft end, and a fourth bottom arm threaded scoop end;
the first scoop comprises of a first top arm hole pair, a first bottom arm hole pair, a first concave side, and a first convex side;
the second scoop comprises of a second top arm hole pair, a second bottom arm hole pair, a second concave side, and a second convex side;
the third scoop comprises of a third top arm hole pair, a third bottom arm hole pair, a third concave side, and a third convex side;
the fourth scoop comprises of a fourth top arm hole pair, a fourth bottom arm hole pair, a fourth concave side, and a fourth convex side;
the first scoop being positioned with the first concave side angled facing down at 20 degrees from a vertical axis and the first convex side angled facing up at 20 degrees from a vertical axis;
the second scoop being positioned with the second concave side angled facing down at 20 degrees from a vertical axis and the second convex side angled facing up at 20 degrees from a vertical axis;
the third scoop being positioned with the third concave side angled facing down at 20 degrees from a vertical axis and the third convex side angled facing up at 20 degrees from a vertical axis;
the fourth scoop being positioned with the fourth concave side angled facing down at 20 degrees from a vertical axis and the fourth convex side angled facing up at 20 degrees from a vertical axis; and
the shaft comprises of a first scoop top hole, a first scoop bottom hole, a second scoop top hole, a second scoop bottom hole, a third scoop top hole, a third scoop bottom hole, a fourth scoop top hole, and a fourth scoop bottom hole.

5. The Balanced Lift Wind Turbine as claimed in claim 1 comprises,
the first frame support comprises of a first support threaded head end, a first support threaded base end, a first top header nut, a first bottom header nut, a first top header washer, a first bottom header washer, a first top footer nut, a first bottom footer nut, a first top footer washer, and a first bottom footer washer;
the second frame support comprises of a second support threaded head end, a second support threaded base end, a second top header nut, a second bottom header nut, a second top header washer, a second bottom header washer, a second top footer nut, a second bottom footer nut, a second top footer washer, and a second bottom footer washer;
the third frame support comprises of a third support threaded head end, a third support threaded base end, a third top header nut, a third bottom header nut, a third top header washer, a third bottom header washer, a third top footer nut, a third bottom footer nut, a third top footer washer, and a third bottom footer washer; and
the fourth frame support comprises of a fourth support threaded head end, a fourth support threaded base end, a fourth top header nut, a fourth bottom header nut, a fourth top header washer, a fourth bottom header washer, a fourth top footer nut, a fourth bottom footer nut, a fourth top footer washer, and a fourth bottom footer washer.

6. The Balanced Lift Wind Turbine as claimed in claim 2 comprises,
the shaft being connected to the sub-shaft by the generator bolt and the generator nut;
the generator being fastened to the base plate by the at least one generator fastener;
the first footer being connected to the first footer threaded fixture by the first threaded footer fixture end;
the second footer being connected to the second footer threaded fixture by the second threaded footer fixture end;
the third footer being connected to the third footer threaded fixture by the third threaded footer fixture end;
the fourth footer being connected to the fourth footer threaded fixture by the fourth threaded footer fixture end;
the first footer being fastened to the base plate by the first base bolt;
the second footer being fastened to the base plate by the second base bolt;
the third footer being fastened to the base plate by the third base bolt; and
the fourth footer being fastened to the base plate by the fourth base bolt.

7. The Balanced Lift Wind Turbine as claimed in claim 3 comprises,
the shaft being connected to the inner collar by the bearing bolt and the bearing nut;
the first header being connected to the first threaded header fixture by the first header fixture threaded end;
the second header being connected to the second threaded header fixture by the second header fixture threaded end;
the third header being connected to the third threaded header fixture by the third header fixture threaded end;
the fourth header being connected to the fourth threaded header fixture by the fourth header fixture threaded end;
the outer collar being welded to the top plate;
the first header being fastened to the top plate by the first top bolt;
the second header being fastened to the top plate by the second top bolt;
the third header being fastened to the top plate by the third top bolt; and
the fourth header being fastened to the top plate by the fourth top bolt.

8. The Balanced Lift Wind Turbine as claimed in claim 4 comprises,
the first scoop being a U-shaped semicircular scoop;
the second scoop being a U-shaped semicircular scoop;
the third scoop being a U-shaped semicircular scoop;
the fourth scoop being a U-shaped semicircular scoop;
the first top arm being fastened to the first scoop top hole of the shaft by the first top arm threaded shaft end;
the second top arm being fastened to the second scoop top hole of the shaft by the second top arm threaded shaft end;
the third top arm being fastened to the third scoop top hole of the shaft by the third top arm threaded shaft end;
the fourth top arm being fastened to the fourth scoop top hole of the shaft by the fourth top arm threaded shaft end;
the first bottom arm being fastened to the first scoop bottom hole of the shaft by the first bottom arm threaded shaft end;
the second bottom arm being fastened to the second scoop bottom hole of the shaft by the second bottom arm threaded shaft end;
the third bottom arm being fastened to the third scoop bottom hole of the shaft by the third bottom arm threaded shaft end;
the fourth bottom arm being fastened to the fourth scoop bottom hole of the shaft by the fourth bottom arm threaded shaft end;
the first top arm threaded scoop end being attached to the first top arm hole pair by the first top arm nut and first top arm washer;
the second top arm threaded scoop end being attached to the second top arm hole pair by the second top arm nut and second top arm washer;
the third top arm threaded scoop end being attached to the third top arm hole pair by the third top arm nut and third top arm washer;
the fourth top arm threaded scoop end being attached to the fourth top arm hole pair by the fourth top arm nut and fourth top arm washer;
the first bottom arm threaded scoop end being attached to the first bottom arm hole pair by the first bottom arm nut and first bottom arm washer;
the second bottom arm threaded scoop end being attached to the second bottom arm hole pair by the second bottom arm nut and second bottom arm washer;
the third bottom arm threaded scoop end being attached to the third bottom arm hole pair by the third bottom arm nut and third bottom arm washer; and
the fourth bottom arm threaded scoop end being attached to the fourth bottom arm hole pair by the fourth bottom arm nut and fourth bottom arm washer.

9. The Balanced Lift Wind Turbine as claimed in claim 5 comprises,
the first support threaded head end being inserted through the first header support hole;
the first support threaded head end being stabilized by the first top header nut, first bottom header nut, first top header washer, first bottom header washer sandwiching the first header;
the second support threaded head end being inserted through the second header support hole;
the second support threaded head end being stabilized by the second top header nut, second bottom header nut, second top header washer, second bottom header washer sandwiching the second header;
the third support threaded head end being inserted through the third header support hole;
the third support threaded head end being stabilized by the third top header nut, third bottom header nut, third top header washer, third bottom header washer sandwiching the third header;
the fourth support threaded head end being inserted through the fourth header support hole;
the fourth support threaded head end being stabilized by the fourth top header nut, fourth bottom header nut, fourth top header washer, fourth bottom header washer sandwiching the fourth header;
the first support threaded base end being inserted through the first footer support hole;
the first support threaded base end being stabilized by the first top footer nut, first bottom footer nut, first top footer washer, first bottom footer washer sandwiching the first footer;
the second support threaded base end being stabilized by the second top footer nut, second bottom footer nut, second top footer washer, second bottom footer washer sandwiching the second footer;
the third support threaded base end being inserted through the third footer support hole;
the third support threaded base end being stabilized by the third top footer nut, third bottom footer nut, third top footer washer, third bottom footer washer sandwiching the third footer;
the fourth support threaded base end being inserted through the fourth footer support hole; and
the fourth support threaded base end being stabilized by the fourth top footer nut, fourth bottom footer nut, fourth top footer washer, fourth bottom footer washer sandwiching the fourth footer.

10. A Balanced Lift Wind Turbine comprises,
a base;
a top;
a scoop support;
a first frame support;
a second frame support;
a third frame support;
a fourth frame support;
the base comprises of a first footer, a second footer, a third footer, a fourth footer, a base plate, a base fixture, a generator, and at least one generator fastener;
the top comprises of a first header, a second header, a third header, a fourth header, a top plate, a bearing, and a top fixture;
the scoop support comprises of a first scoop, a second scoop, a third scoop, a fourth scoop, a first top arm, a second top arm, a third top arm, a fourth top arm, a first bottom arm, a second bottom arm, a third bottom arm, a fourth bottom arm, and a shaft;
the first scoop being positioned at a predetermined angle;
the second scoop being positioned at a predetermined angle;
the third scoop being positioned at a predetermined angle;
the fourth scoop being positioned at a predetermined angle;
the first footer comprises of a first footer fixture threaded end, a first footer support hole;
the second footer comprises of a second footer fixture threaded end, a second footer support hole;
the third footer comprises of a third footer fixture threaded end, a third footer support hole;
the fourth footer comprises of a fourth footer fixture threaded end, a fourth footer support hole;
the first header comprises of a first header fixture threaded end, a first header support hole;
the second header comprises of a second header fixture threaded end, a second header support hole;
the third header comprises of a third header fixture threaded end, a third header support hole;
the fourth header comprises of a fourth header fixture threaded end, a fourth header support hole;
the first frame support comprises of a first support threaded head end, a first support threaded base end, a first top header nut, a first bottom header nut, a first top header washer, a first bottom header washer, a first top footer nut, a first bottom footer nut, a first top footer washer, and a first bottom footer washer;
the second frame support comprises of a second support threaded head end, a second support threaded base end, a second top header nut, a second bottom header nut, a second top header washer, a second bottom header washer, a second top footer nut, a second bottom footer nut, a second top footer washer, and a second bottom footer washer;
the third frame support comprises of a third support threaded head end, a third support threaded base end, a third top header nut, a third bottom header nut, a third top header washer, a third bottom header washer, a third top footer nut, a third bottom footer nut, a third top footer washer, and a third bottom footer washer;
the fourth frame support comprises of a fourth support threaded head end, a fourth support threaded base end, a fourth top header nut, a fourth bottom header nut, a fourth top header washer, a fourth bottom header washer, a fourth top footer nut, a fourth bottom footer nut, a fourth top footer washer, and a fourth bottom footer washer;
the first support threaded head end being inserted through the first header support hole;
the first support threaded head end being stabilized by the first top header nut, first bottom header nut, first top header washer, first bottom header washer sandwiching the first header;
the second support threaded head end being inserted through the second header support hole;
the second support threaded head end being stabilized by the second top header nut, second bottom header nut, second top header washer, second bottom header washer sandwiching the second header;
the third support threaded head end being inserted through the third header support hole;
the third support threaded head end being stabilized by the third top header nut, third bottom header nut, third top header washer, third bottom header washer sandwiching the third header;
the fourth support threaded head end being inserted through the fourth header support hole;
the fourth support threaded head end being stabilized by the fourth top header nut, fourth bottom header nut, fourth top header washer, fourth bottom header washer sandwiching the fourth header;
the first support threaded base end being inserted through the first footer support hole;
the first support threaded base end being stabilized by the first top footer nut, first bottom footer nut, first top footer washer, first bottom footer washer sandwiching the first footer;
the second support threaded base end being stabilized by the second top footer nut, second bottom footer nut, second top footer washer, second bottom footer washer sandwiching the second footer;
the third support threaded base end being inserted through the third footer support hole;
the third support threaded base end being stabilized by the third top footer nut, third bottom footer nut, third top footer washer, third bottom footer washer sandwiching the third footer;
the fourth support threaded base end being inserted through the fourth footer support hole; and
the fourth support threaded base end being stabilized by the fourth top footer nut, fourth bottom footer nut, fourth top footer washer, fourth bottom footer washer sandwiching the fourth footer.

11. The Balanced Lift Wind Turbine as claimed in claim 10 comprises,
the generator comprises of a sub-shaft, generator bolt, and a generator nut;
the base fixture comprises of a first threaded footer fixture, a second threaded footer fixture, a third threaded footer fixture, and a fourth threaded footer fixture;
a first base bolt;
a second base bolt;
a third base bolt; and
a fourth base bolt.

12. The Balanced Lift Wind Turbine as claimed in claim 10 comprises,
the bearing comprising of an outer collar, an inner collar, a bearing bolt, and a bearing nut;
the top fixture comprising of a first threaded header fixture, a second threaded header fixture, a third threaded header fixture, and a fourth threaded header fixture;
a first top bolt;
a second top bolt;
a third top bolt; and
a fourth top bolt.

13. The Balanced Lift Wind Turbine as claimed in claim 10 comprises,
the first top arm comprises of a first top arm washer, a first top arm nut, a first top arm threaded shaft end, and a first top arm threaded scoop end;
the second top arm comprises of a second top arm washer, a second top arm nut, a second top arm threaded shaft end, and a second top arm threaded scoop end;
the third top arm comprises of a third top arm washer, a third top arm nut a third top arm threaded shaft end, and a third top arm threaded scoop end;
the fourth top arm comprises of a fourth top arm washer, a fourth top arm nut, a fourth top arm threaded shaft end, and a fourth top arm threaded scoop end;
the first bottom arm comprises of a first bottom arm washer, a first bottom arm nut, a first bottom arm threaded shaft end, and a first bottom arm threaded scoop end;
the second bottom arm comprises of a second bottom arm washer, a second bottom arm nut, a second bottom arm threaded shaft end, and a second bottom arm threaded scoop end;
the third bottom arm comprises of a third bottom arm washer, a third bottom arm nut a third bottom arm threaded shaft end, and a third bottom arm threaded scoop end;
the fourth bottom arm comprises of a fourth bottom arm washer, a fourth bottom arm nut, a fourth bottom arm threaded shaft end, and a fourth bottom arm threaded scoop end;
the first scoop comprises of a first top arm hole pair, a first bottom arm hole pair, a first concave side, and a first convex side;
the second scoop comprises of a second top arm hole pair, a second bottom arm hole pair, a second concave side, and a second convex side;
the third scoop comprises of a third top arm hole pair, a third bottom arm hole pair, a third concave side, and a third convex side;
the fourth scoop comprises of a fourth top arm hole pair, a fourth bottom arm hole pair, a fourth concave side, and a fourth convex side;
the first scoop being positioned with the first concave side angled facing down at 20 degrees from a vertical axis and the first convex side angled facing up at 20 degrees from a vertical axis;
the second scoop being positioned with the second concave side angled facing down at 20 degrees from a vertical axis and the second convex side angled facing up at 20 degrees from a vertical axis;
the third scoop being positioned with the third concave side angled facing down at 20 degrees from a vertical axis and the third convex side angled facing up at 20 degrees from a vertical axis;
the fourth scoop being positioned with the fourth concave side angled facing down at 20 degrees from a vertical axis and the fourth convex side angled facing up at 20 degrees from a vertical axis;
the shaft comprises of a first scoop top hole, a first scoop bottom hole, a second scoop top hole, a second scoop bottom hole, a third scoop top hole, a third scoop bottom hole, a fourth scoop top hole, and a fourth scoop bottom hole;
the first scoop being a U-shaped semicircular scoop;
the second scoop being a U-shaped semicircular scoop;
the third scoop being a U-shaped semicircular scoop;
the fourth scoop being a U-shaped semicircular scoop;
the first top arm being fastened to the first scoop top hole of the shaft by the first top arm threaded shaft end;
the second top arm being fastened to the second scoop top hole of the shaft by the second top arm threaded shaft end;
the third top arm being fastened to the third scoop top hole of the shaft by the third top arm threaded shaft end;
the fourth top arm being fastened to the fourth scoop top hole of the shaft by the fourth top arm threaded shaft end;
the first bottom arm being fastened to the first scoop bottom hole of the shaft by the first bottom arm threaded shaft end;
the second bottom arm being fastened to the second scoop bottom hole of the shaft by the second bottom arm threaded shaft end;
the third bottom arm being fastened to the third scoop bottom hole of the shaft by the third bottom arm threaded shaft end;
the fourth bottom arm being fastened to the fourth scoop bottom hole of the shaft by the fourth bottom arm threaded shaft end;
the first top arm threaded scoop end being attached to the first top arm hole pair by the first top arm nut and first top arm washer;
the second top arm threaded scoop end being attached to the second top arm hole pair by the second top arm nut and second top arm washer;
the third top arm threaded scoop end being attached to the third top arm hole pair by the third top arm nut and third top arm washer;
the fourth top arm threaded scoop end being attached to the fourth top arm hole pair by the fourth top arm nut and fourth top arm washer;
the first bottom arm threaded scoop end being attached to the first bottom arm hole pair by the first bottom arm nut and first bottom arm washer;
the second bottom arm threaded scoop end being attached to the second bottom arm hole pair by the second bottom arm nut and second bottom arm washer;
the third bottom arm threaded scoop end being attached to the third bottom arm hole pair by the third bottom arm nut and third bottom arm washer; and
the fourth bottom arm threaded scoop end being attached to the fourth bottom arm hole pair by the fourth bottom arm nut and fourth bottom arm washer.

14. The Balanced Lift Wind Turbine as claimed in claim 11 comprises,
the shaft being connected to the sub-shaft by the generator bolt and the generator nut;
the generator being fastened to the base plate by the at least one generator fastener;
the first footer being connected to the first footer threaded fixture by the first threaded footer fixture end;
the second footer being connected to the second footer threaded fixture by the second threaded footer fixture end;
the third footer being connected to the third footer threaded fixture by the third threaded footer fixture end;
the fourth footer being connected to the fourth footer threaded fixture by the fourth threaded footer fixture end;
the first footer being fastened to the base plate by the first base bolt;
the second footer being fastened to the base plate by the second base bolt;
the third footer being fastened to the base plate by the third base bolt; and
the fourth footer being fastened to the base plate by the fourth base bolt.

15. The Balanced Lift Wind Turbine as claimed in claim 12 comprises,
the shaft being connected to the inner collar by the bearing bolt and the bearing nut;
the first header being connected to the first threaded header fixture by the first header fixture threaded end;
the second header being connected to the second threaded header fixture by the second header fixture threaded end;
the third header being connected to the third threaded header fixture by the third header fixture threaded end;
the fourth header being connected to the fourth threaded header fixture by the fourth header fixture threaded end;
the outer collar being welded to the top plate;
the first header being fastened to the top plate by the first top bolt;
the second header being fastened to the top plate by the second top bolt;
the third header being fastened to the top plate by the third top bolt; and
the fourth header being fastened to the top plate by the fourth top bolt.

16. A Balanced Lift Wind Turbine comprises,
a base;
a top;
a scoop support;
a first frame support;
a second frame support;
a third frame support;
a fourth frame support;
the base comprises of a first footer, a second footer, a third footer, a fourth footer, a base plate, a base fixture, a generator, and at least one generator fastener;
the top comprises of a first header, a second header, a third header, a fourth header, a top plate, a bearing, and a top fixture;
the scoop support comprises of a first scoop, a second scoop, a third scoop, a fourth scoop, a first top arm, a second top arm, a third top arm, a fourth top arm, a first bottom arm, a second bottom arm, a third bottom arm, a fourth bottom arm, and a shaft;
the first scoop being positioned at a predetermined angle;
the second scoop being positioned at a predetermined angle;
the third scoop being positioned at a predetermined angle;
the fourth scoop being positioned at a predetermined angle;
the first footer comprises of a first footer fixture threaded end, a first footer support hole;
the second footer comprises of a second footer fixture threaded end, a second footer support hole;
the third footer comprises of a third footer fixture threaded end, a third footer support hole;
the fourth footer comprises of a fourth footer fixture threaded end, a fourth footer support hole;
the first header comprises of a first header fixture threaded end, a first header support hole;
the second header comprises of a second header fixture threaded end, a second header support hole;
the third header comprises of a third header fixture threaded end, a third header support hole;
the fourth header comprises of a fourth header fixture threaded end, a fourth header support hole;
the generator comprises of a sub-shaft, generator bolt, and a generator nut;
the base fixture comprises of a first threaded footer fixture, a second threaded footer fixture, a third threaded footer fixture, and a fourth threaded footer fixture;
a first base bolt;
a second base bolt;
a third base bolt;
a fourth base bolt;
the bearing comprising of an outer collar, an inner collar, a bearing bolt, and a bearing nut;
the top fixture comprising of a first threaded header fixture, a second threaded header fixture, a third threaded header fixture, and a fourth threaded header fixture;
a first top bolt;
a second top bolt;
a third top bolt;
a fourth top bolt;
the first top arm comprises of a first top arm washer, a first top arm nut, a first top arm threaded shaft end, and a first top arm threaded scoop end;
the second top arm comprises of a second top arm washer, a second top arm nut, a second top arm threaded shaft end, and a second top arm threaded scoop end;
the third top arm comprises of a third top arm washer, a third top arm nut a third top arm threaded shaft end, and a third top arm threaded scoop end;
the fourth top arm comprises of a fourth top arm washer, a fourth top arm nut, a fourth top arm threaded shaft end, and a fourth top arm threaded scoop end;
the first bottom arm comprises of a first bottom arm washer, a first bottom arm nut, a first bottom arm threaded shaft end, and a first bottom arm threaded scoop end;
the second bottom arm comprises of a second bottom arm washer, a second bottom arm nut, a second bottom arm threaded shaft end, and a second bottom arm threaded scoop end;
the third bottom arm comprises of a third bottom arm washer, a third bottom arm nut a third bottom arm threaded shaft end, and a third bottom arm threaded scoop end;
the fourth bottom arm comprises of a fourth bottom arm washer, a fourth bottom arm nut, a fourth bottom arm threaded shaft end, and a fourth bottom arm threaded scoop end;
the first scoop comprises of a first top arm hole pair, a first bottom arm hole pair, a first concave side, and a first convex side;
the second scoop comprises of a second top arm hole pair, a second bottom arm hole pair, a second concave side, and a second convex side;
the third scoop comprises of a third top arm hole pair, a third bottom arm hole pair, a third concave side, and a third convex side;
the fourth scoop comprises of a fourth top arm hole pair, a fourth bottom arm hole pair, a fourth concave side, and a fourth convex side;
the first scoop being positioned with the first concave side angled facing down at 20 degrees from a vertical axis and the first convex side angled facing up at 20 degrees from a vertical axis;
the second scoop being positioned with the second concave side angled facing down at 20 degrees from a vertical axis and the second convex side angled facing up at 20 degrees from a vertical axis;
the third scoop being positioned with the third concave side angled facing down at 20 degrees from a vertical axis and the third convex side angled facing up at 20 degrees from a vertical axis;
the fourth scoop being positioned with the fourth concave side angled facing down at 20 degrees from a vertical axis and the fourth convex side angled facing up at 20 degrees from a vertical axis;
the shaft comprises of a first scoop top hole, a first scoop bottom hole, a second scoop top hole, a second scoop bottom hole, a third scoop top hole, a third scoop bottom hole, a fourth scoop top hole, and a fourth scoop bottom hole;
the first frame support comprises of a first support threaded head end, a first support threaded base end, a first top header nut, a first bottom header nut, a first top header washer, a first bottom header washer, a first top footer nut, a first bottom footer nut, a first top footer washer, and a first bottom footer washer;
the second frame support comprises of a second support threaded head end, a second support threaded base end, a second top header nut, a second bottom header nut, a second top header washer, a second bottom header washer, a second top footer nut, a second bottom footer nut, a second top footer washer, and a second bottom footer washer;
the third frame support comprises of a third support threaded head end, a third support threaded base end, a third top header nut, a third bottom header nut, a third top header washer, a third bottom header washer, a third top footer nut, a third bottom footer nut, a third top footer washer, and a third bottom footer washer; and
the fourth frame support comprises of a fourth support threaded head end, a fourth support threaded base end, a fourth top header nut, a fourth bottom header nut, a fourth top header washer, a fourth bottom header washer, a fourth top footer nut, a fourth bottom footer nut, a fourth top footer washer, and a fourth bottom footer washer.

17. The Balanced Lift Wind Turbine as claimed in claim 16 comprises,
the shaft being connected to the sub-shaft by the generator bolt and the generator nut;
the generator being fastened to the base plate by the at least one generator fastener;
the first footer being connected to the first footer threaded fixture by the first threaded footer fixture end;
the second footer being connected to the second footer threaded fixture by the second threaded footer fixture end;
the third footer being connected to the third footer threaded fixture by the third threaded footer fixture end;
the fourth footer being connected to the fourth footer threaded fixture by the fourth threaded footer fixture end;
the first footer being fastened to the base plate by the first base bolt;
the second footer being fastened to the base plate by the second base bolt;
the third footer being fastened to the base plate by the third base bolt; and
the fourth footer being fastened to the base plate by the fourth base bolt.

18. The Balanced Lift Wind Turbine as claimed in claim 16 comprises,
the shaft being connected to the inner collar by the bearing bolt and the bearing nut;
the first header being connected to the first threaded header fixture by the first header fixture threaded end;
the second header being connected to the second threaded header fixture by the second header fixture threaded end;
the third header being connected to the third threaded header fixture by the third header fixture threaded end;
the fourth header being connected to the fourth threaded header fixture by the fourth header fixture threaded end;
the outer collar being welded to the top plate;
the first header being fastened to the top plate by the first top bolt;
the second header being fastened to the top plate by the second top bolt;
the third header being fastened to the top plate by the third top bolt; and
the fourth header being fastened to the top plate by the fourth top bolt.

19. The Balanced Lift Wind Turbine as claimed in claim 16 comprises,
the first scoop being a U-shaped semicircular scoop;
the second scoop being a U-shaped semicircular scoop;
the third scoop being a U-shaped semicircular scoop;
the fourth scoop being a U-shaped semicircular scoop;
the first top arm being fastened to the first scoop top hole of the shaft by the first top arm threaded shaft end;
the second top arm being fastened to the second scoop top hole of the shaft by the second top arm threaded shaft end;
the third top arm being fastened to the third scoop top hole of the shaft by the third top arm threaded shaft end;
the fourth top arm being fastened to the fourth scoop top hole of the shaft by the fourth top arm threaded shaft end;
the first bottom arm being fastened to the first scoop bottom hole of the shaft by the first bottom arm threaded shaft end;
the second bottom arm being fastened to the second scoop bottom hole of the shaft by the second bottom arm threaded shaft end;
the third bottom arm being fastened to the third scoop bottom hole of the shaft by the third bottom arm threaded shaft end;
the fourth bottom arm being fastened to the fourth scoop bottom hole of the shaft by the fourth bottom arm threaded shaft end;
the first top arm threaded scoop end being attached to the first top arm hole pair by the first top arm nut and first top arm washer;
the second top arm threaded scoop end being attached to the second top arm hole pair by the second top arm nut and second top arm washer;
the third top arm threaded scoop end being attached to the third top arm hole pair by the third top arm nut and third top arm washer;
the fourth top arm threaded scoop end being attached to the fourth top arm hole pair by the fourth top arm nut and fourth top arm washer;
the first bottom arm threaded scoop end being attached to the first bottom arm hole pair by the first bottom arm nut and first bottom arm washer;
the second bottom arm threaded scoop end being attached to the second bottom arm hole pair by the second bottom arm nut and second bottom arm washer;
the third bottom arm threaded scoop end being attached to the third bottom arm hole pair by the third bottom arm nut and third bottom arm washer; and
the fourth bottom arm threaded scoop end being attached to the fourth bottom arm hole pair by the fourth bottom arm nut and fourth bottom arm washer.

20. The Balanced Lift Wind Turbine as claimed in claim 16 comprises,
the first support threaded head end being inserted through the first header support hole;
the first support threaded head end being stabilized by the first top header nut, first bottom header nut, first top header washer, first bottom header washer sandwiching the first header;
the second support threaded head end being inserted through the second header support hole;
the second support threaded head end being stabilized by the second top header nut, second bottom header nut, second top header washer, second bottom header washer sandwiching the second header;
the third support threaded head end being inserted through the third header support hole;
the third support threaded head end being stabilized by the third top header nut, third bottom header nut, third top header washer, third bottom header washer sandwiching the third header;
the fourth support threaded head end being inserted through the fourth header support hole;
the fourth support threaded head end being stabilized by the fourth top header nut, fourth bottom header nut, fourth top header washer, fourth bottom header washer sandwiching the fourth header;
the first support threaded base end being inserted through the first footer support hole;
the first support threaded base end being stabilized by the first top footer nut, first bottom footer nut, first top footer washer, first bottom footer washer sandwiching the first footer;
the second support threaded base end being stabilized by the second top footer nut, second bottom footer nut, second top footer washer, second bottom footer washer sandwiching the second footer;
the third support threaded base end being inserted through the third footer support hole;
the third support threaded base end being stabilized by the third top footer nut, third bottom footer nut, third top footer washer, third bottom footer washer sandwiching the third footer;
the fourth support threaded base end being inserted through the fourth footer support hole; and
the fourth support threaded base end being stabilized by the fourth top footer nut, fourth bottom footer nut, fourth top footer washer, fourth bottom footer washer sandwiching the fourth footer.
